(19) United States
(12) Patent Application Publication
(10) Pub. No.: US 2006/0237618 A1
(43) Pub. Date: Oct. 26, 2006

(54) Support device for monitor, display or objects

(76) Inventor: Sun Hong Chiang, Taoyuan City (TW)

Correspondence Address: CHARLES E. BAXLEY, ESQ., 90 JOHN STREET, THIRD FLOOR, NEW YORK, NY, 10038, US

(21) Appl. No.: 11/080,190

(22) Filed: Mar. 15, 2005

(51) Int. Cl. F16M 11/00

(52) U.S. Cl. 248/404

(57) ABSTRACT

A support device includes a housing having a chamber to slidably receive a sliding member. An object is attached on top of the sliding member, and moved in concert with the sliding member, and a spring biasing device is coupled between the sliding member and the housing, for applying a spring biasing force to hold and maintain the sliding member relative to the housing at any selected position. The spring biasing device includes a spring blade engaged around a shaft, and having an engaging member for coupling to the sliding member. One or more frictional members may be attached to the sliding member for frictionally engaging with the housing, and for positioning the sliding member to the housing at the selected position.

### BACKGROUND OF THE INVENTION

1. Field of the Invention

The present invention relates to a support device, and more particularly to a support device having a simplified structure for supporting monitors, displays, or other objects thereon.

2. Description of the Prior Art

Typical support devices for supporting monitors, displays, or other objects thereon have been developed and comprise a number of linking elements or elbows or arms coupled between a base member and a frame that may be secured or attached to the monitors, the displays, or the other objects.

For example, U.S. Pat. No. 6,769,657 to Huang discloses one of the typical support devices for supporting monitors, displays, or other objects thereon, and includes a complicated parallelogrammic structure having a number of linking elements or elbows or arms coupled together, such that the typical typical support devices may not be easily manufactured and assembled together.

U.S. Pat. No. 6,822,857 to Jung et al. discloses another typical support device for supporting monitors, displays, or other objects thereon, and also includes a link member pivotally coupled between a base member and a main bracket with hinges. However, the base member and the main bracket may have a good chance to be bent or folded relative to the link member, such that the monitors, the displays, or the other objects supported on the main bracket may have a good chance to be damaged inadvertently.

The present invention has arisen to mitigate and/or obviate the afore-described disadvantages of the conventional support devices for supporting monitors, displays, or other objects thereon.

### SUMMARY OF THE INVENTION

The primary objective of the present invention is to provide a support device including a simplified structure for supporting monitors, displays, or other objects thereon.

In accordance with one aspect of the invention, there is provided a support device comprising a housing including a chamber formed therein, a sliding member slidably engaged into the chamber of the housing, an object attached on top of the sliding member, and moved in concert with the sliding member, and a spring biasing device coupled between the sliding member and the housing, for applying a spring biasing force to hold and maintain the sliding member relative to the housing at any selected position, such that support device may include a simplified structure for supporting monitors, displays, or other objects thereon.

The housing includes two side panels and a rear panel to define the chamber thereof, and an orifice formed in each of the side panels thereof, and communicating with the chamber thereof, the spring biasing device includes a shaft rotatably engaged in the orifices of the side panels of the housing.

The spring biasing device includes a spring blade engaged around the shaft, and includes an engaging member attached to a free end of the spring blade, for coupling to the sliding member. The engaging member of the spring biasing device includes at least one notch formed therein, and the sliding member includes at least one projection extended therein, and engaged with the notch of the engaging member of the spring blade, for coupling the spring biasing device to the sliding member.

The sliding member includes a chamber formed therein, to receive the spring biasing device, and includes two side walls each having a longitudinal channel formed therein, to slidably receive the shaft, and to guide the sliding member to slide and to move up and down relative to the housing.

The sliding member includes at least one frictional member attached thereto, for frictionally engaging with the housing, and for positioning the sliding member to the housing at the selected position. The housing includes a passage formed in a front portion thereof, to define two front panels, and a cover plate secured to the front panels of the housing, in order to block and cover the passage of the housing.

The housing includes at least one leg laterally extended from a bottom portion thereof, and the cover plate includes a leg laterally extended from a bottom portion thereof, for forming a stable structure to the housing. An outer covering may further be provided and attached onto the housing, in order to form a smooth outer appearance for the support device. An outer receptacle may further be provided and attached onto the sliding member, to form a smooth outer appearance.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial plan schematic view of a support device in accordance with the present invention;

FIG. 2 is a perspective view illustrating a main supporting mechanism of the support device;

FIG. 3 is a partial exploded view of main supporting mechanism of the support device;

FIG. 4 is an exploded view of main supporting mechanism of the support device; and

FIG. 5 is a partial plan schematic view similar to FIG. 1, illustrating the operation of the support device.

### DETAILED DESCRIPTION OF THE PREFERRED EMBODIMENT

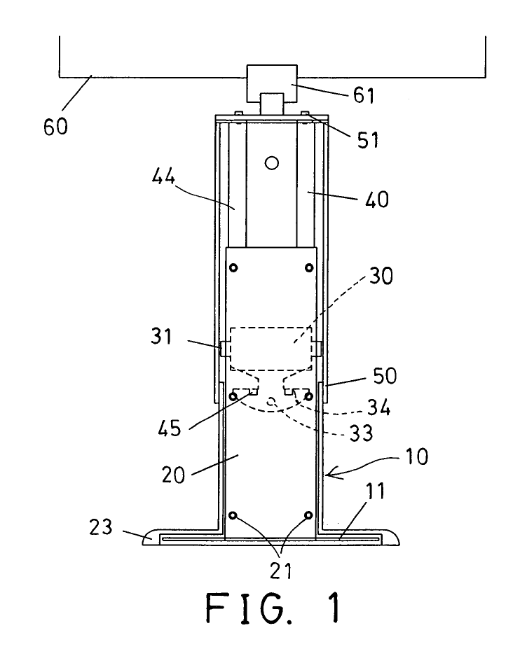

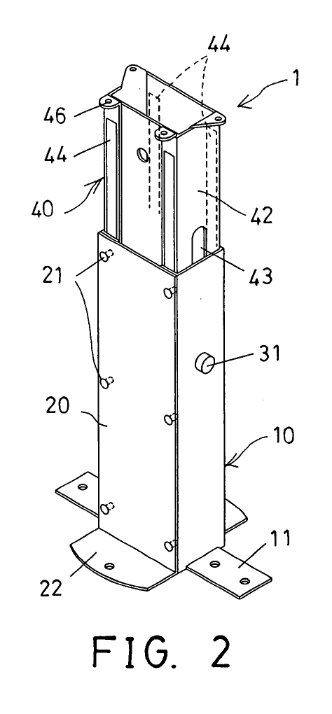

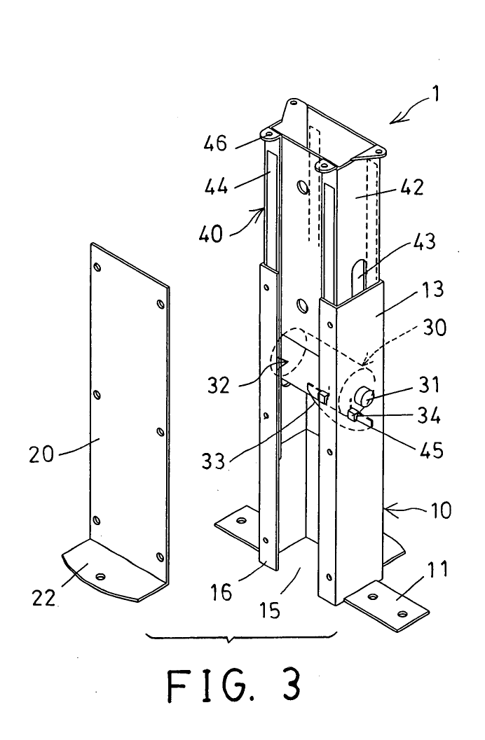

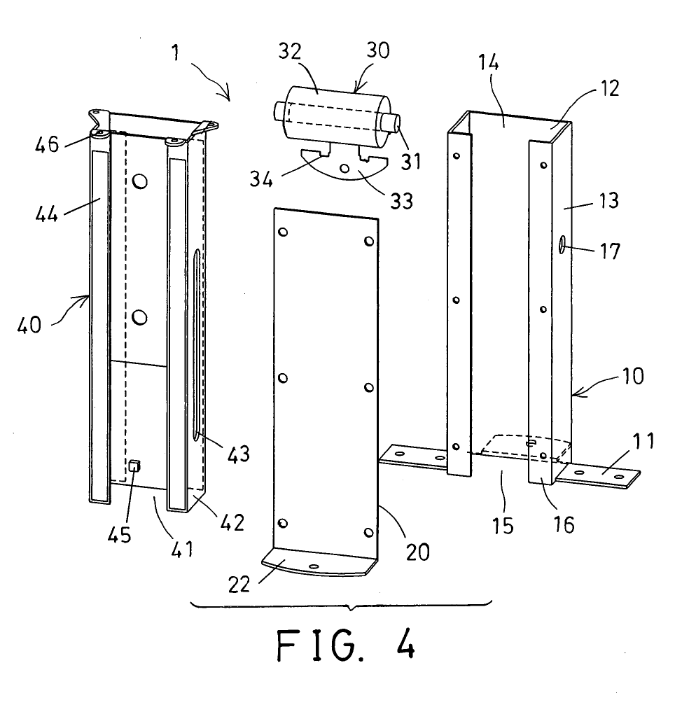

Referring to the drawings, and initially to FIGS. 1-4, a support device in accordance with the present invention comprises a main supporting mechanism 1 including a housing 10 having one or more legs 11 laterally extended from the bottom portion thereof, for forming a stable structure, and for allowing the housing 10 to be stably disposed and supported on the ground or other supporting surfaces.

The housing 10 includes a chamber 12 formed therein, and defined by two side panels 13, a rear panel 14, and includes a passage 15 formed in the front portion thereof, to form or define two front panels 16. The housing 10 further includes an orifice 17 formed in each of the side panels 13 thereof, and communicating with the chamber 12 thereof, the orifices 17 of the two side panels 13 are aligned with each other.

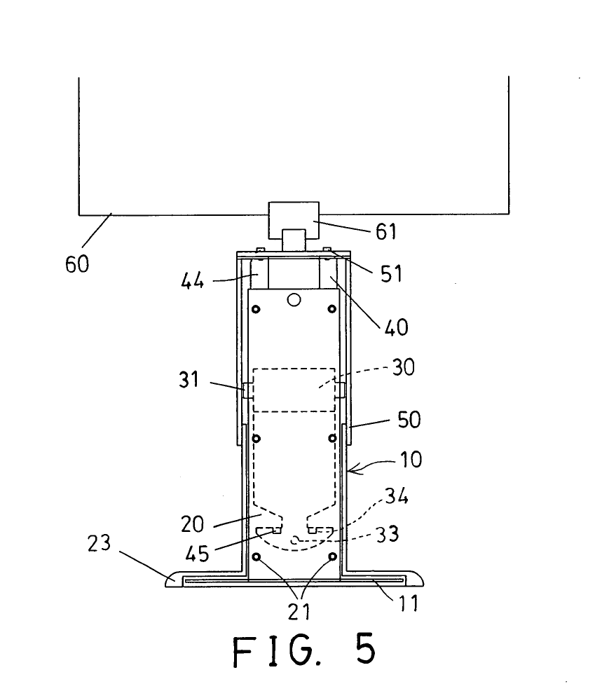

A cover plate 20 may further be provided and secured to the front panels 16 of the housing 10 with such as fasteners 21 (FIGS. 1, 5), in order to block or cover the passage 15 of the housing 10. The cover plate 20 includes a leg 22 laterally extended from the bottom portion thereof, for further forming a stable structure to the housing 10, and for further allowing the housing 10 to be stably supported on the ground or other supporting surfaces.

A spring biasing device 30 may further be provided and disposed in the housing 10, and includes a shaft 31 rotatably engaged in the orifices 17 of the side panels 13 of the housing 10, and includes a coil spring or spring blade 32 engaged or wound around the shaft 31, and includes an engaging member 33 formed or provided or attached to one end or free end of the spring blade 32 and having one or more notches 34 formed therein. As shown in FIGS. 1 and 5, an outer covering 23 may further be provided and attached or secured onto or molded onto the housing 10 and the cover plate 20, to form a smooth outer appearance.

A sliding member 40 is slidably engaged into the chamber 12 of the housing 10, and also includes a chamber 41 formed therein, to receive the spring biasing device 30, and includes two side walls 42 each having a longitudinal channel 43 formed therein, to slidably receive the shaft 31 therein, and thus to stably guide the sliding member 40 to slide or to move up and down relative to the housing 10.

It is preferable that the sliding member 40 includes one or more tracks or frictional members 44 attached thereto, for frictionally engaging with the housing 10, and for positioning the sliding member 40 to the housing 10 at any selected position or height. However, without the frictional members 44, the sliding member 40 may also be frictionally engaged within the housing 10 by such as force-fitted engagements or the like.

The sliding member 40 further includes one or more hooks or projections 45 extended therein, such as extended into the chamber 41 thereof, and engaged with or into the notches 34 of the engaging member 33 of the spring blade 32, for allowing the spring biasing device 30 to be coupled between the sliding member 40 and the housing 10, and for allowing the spring blade 32 of the spring biasing device 30 to apply a spring biasing force to hold or maintain the sliding member 40 relative to the housing 10 at the selected position or height (FIGS. 1, 5).

An outer receptacle 50 may further be provided and engaged or attached onto the sliding member 40, to form a smooth outer appearance, and to shield the shaft 31 and the longitudinal channels 43 of the sliding member 40, and to prevent dirt or particles or contaminants from entering into the sliding member 40 and the housing 10. For example, the sliding member 40 may include one or more extensions 46 laterally extended from the upper portion thereof, for securing to the outer receptacle 50 with one or more fasteners 51.

An object 60, such as a monitor, a display, or other objects 60 may include a lower portion 61 secured to the outer receptacle 50, or directly secured to the sliding member 40, to allow the object 60 and the outer receptacle 50, and/or the sliding member 40 to be moved in concert with each other.

In operation, as shown in FIGS. 1 and 5, when the object 60 and/or the outer receptacle 50 and/or the sliding member 40 is moved up and down relative to the housing 10, the spring blade 32 of the spring biasing device 30 may apply a spring biasing force to hold or maintain the sliding member 40 relative to the housing 10 at any selected position or height. The frictional engagement between the sliding member 40 and the housing 10 may further be provided to hold or maintain the sliding member 40 relative to the housing 10 at any selected position or height.

Accordingly, the support device in accordance with the present invention includes a simplified structure for supporting monitors, displays, or other objects thereon.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A support device comprising:
a housing including a chamber formed therein,
a sliding member slidably engaged into said chamber of said housing,
an object attached on top of said sliding member, and moved in concert with said sliding member, and
a spring biasing device coupled between said sliding member and said housing, for applying a spring biasing force to hold and maintain said sliding member relative to said housing at selected position.

2. The support device as claimed in claim 1, wherein said housing includes two side panels and a rear panel to define said chamber thereof, and an orifice formed in each of said side panels thereof, and communicating with said chamber thereof, said spring biasing device includes a shaft rotatably engaged in said orifices of said side panels of said housing.

3. The support device as claimed in claim 2, wherein said spring biasing device includes a spring blade engaged around said shaft, and includes an engaging member attached to a free end of said spring blade, for coupling to said sliding member.

4. The support device as claimed in claim 3, wherein said engaging member of said spring biasing device includes at least one notch formed therein, and said sliding member includes at least one projection extended therein, and engaged with said at least one notch of said engaging member of said spring blade, for coupling said spring biasing device to said sliding member.

5. The support device as claimed in claim 2, wherein said sliding member includes a chamber formed therein, to receive said spring biasing device, and includes two side walls each having a longitudinal channel formed therein, to slidably receive said shaft, and to guide said sliding member to slide and to move up and down relative to said housing.

6. The support device as claimed in claim 1, wherein said sliding member includes at least one frictional member attached thereto, for frictionally engaging with said housing, and for positioning said sliding member to said housing at the selected position.

7. The support device as claimed in claim 1, wherein said housing includes a passage formed in a front portion thereof, to define two front panels, and a cover plate secured to said front panels of said housing, in order to block and cover said passage of said housing.

8. The support device as claimed in claim 1, wherein said housing includes at least one leg laterally extended from a bottom portion thereof, and said cover plate includes a leg laterally extended from a bottom portion thereof, for forming a stable structure to said housing.

9. The support device as claimed in claim 1 further comprising an outer covering attached onto said housing, to form a smooth outer appearance.

10. The support device as claimed in claim 1 further comprising an outer receptacle attached onto said sliding member, to form a smooth outer appearance.
